(19) United States
(12) Patent Application Publication
(10) Pub. No.: US 2024/0013142 A1
(43) Pub. Date: Jan. 11, 2024

(54) END-TO-END DATA ANALYTICS SYSTEM AND METHOD FOR PRODUCT PRODUCTION AND SALES

(71) Applicant: LEGACYSECURE, INC., (US)

(72) Inventors: Chris Romine, Riverside, CA (US); Noah Klein, New Rochelle, NY (US); Patrick Cooley, Arlington, VA (US); David Robinson, Montgomery Village, MD (US); Jim Kuster, Sagamore Hills, OH (US)

(21) Appl. No.: 17/859,158

(22) Filed: Jul. 7, 2022

(51) Int. Cl. G06Q 10/08; G06Q 30/02

(52) U.S. Cl. CPC G06Q 10/087; G06Q 30/0282; G06Q 30/0276

(57) ABSTRACT

A system for tracking data related to a cigar. The system has a tracking database configured to receive input from at least an environmental database for providing environmental data relating the manufacturer of the cigar to the tracking database. At least one additional tracking system receives subsequent data relating to the handling of the cigar, after manufacturer. The tracking database assembles a tracking database entry uniquely associated with the cigar. The tracking database entry also includes at least said environmental data and the subsequent data relating to the handling of the cigar. The tracking database is configured to provide a tracking database entry associated uniquely connected with the cigar to at least two different users, where each of said at least two different users can review the tracking database entry under a different level of access.

### RELATED APPLICATION

This application is a continuation-in-part of U.S. patent application Ser. No. 17/239,234 filed on Apr. 23, 2021, the entirety of which is incorporated by reference.

### FIELD OF THE INVENTION

This application relates to an end-to-end data analytics system and method for product production and sales. More particularly, the present application relates to an end-to-end data analytics system and method for product production and sales, allowing different layers of data access at various stages of the production and sales chain.

### DESCRIPTION OF RELATED ART

In the tobacco and cigar industry, there is a lack of full end-to-end data analytics along the entire supply chain, from manufacture all the way to through to sales. Much of the data is collected by hand at various stages with little integration making it difficult to accurately tie production data though to sales and product review data. There is an overall lack of the “big picture” of the life of a product making it difficult to tie insights from different aspects of the business together.

For example, starting with the production of cigars, fermentation is the process that accounts for most of the changes and distinctions in cigar tobaccos. Fermentation is a process for allowing the tobacco to heat up under the pressure of its own weight. The fermentation is usually broken into at least two stages.

In the first stage of fermentation the tobacco leaves are bunched together in “gavillas” (small bunches) which are in turn piled in the small piles (e.g. ½ to 1 meters). The piles are referred to as “pilones.” Owing to the natural decomposition of the tobacco leaves and under the pressure and weight of the piles, the temperature can run around 90°-100° Fahrenheit. In some instances, the pilones are broken down, cooled and reformed if the temperature is excessive. This first fermentation process takes several weeks to several months depending on the tobacco manufacturer until the leaves are fermented and aged at which point the leaves are sorted and classified according to color, texture, and type of leaf including wrappers, binders, and fillers wrappers based on various qualities and characteristics of the leaves and other pre-processing steps (e.g. some sorting and leaf preparation may occur before this first fermentation).

The second fermentation step typically includes a re-humidification of the leaves and regathering into much larger “burros” which can be 1-2 meters in in height (and a meter or more in diameter). The burros can weigh more than a thousand pounds, and with the added water, the fermentation process begins anew and more intensely. This second fermentation can last 60 or more days or more releasing large amounts of ammonia and developing the flavor profile of the leaves. During this fermentation, again the temperature rises over 100° Fahrenheit up to almost 140° or more. As with the Pilones, if the temperature becomes excessive it can damage the leaves, so the burros are unraveled, cooled, and restacked for additional fermentation if needed.

During both processes, carefully controlling the temperature and humidity allows for the removal of the unwanted ammonia and impurities while simultaneously developing the particular tastes, smells and “flavors” the leaves. If the humidity or temperature at any point is too high, or too low, or changes too fast, it could negatively affect the tobacco leaves.

In the prior art, such fermentation practices developed over centuries or decades as more of an art form than anything else. Although the principals of fermentation were known, the climate control was simply done by observation and industry practices. More recently, the tobacco industry, including the cigar tobacco industry, has adopted more scientific means of fermentation control including the use of thermometers and hygrometers.

Never-the-less the state of the art does not allow for full climate control on a real time basis. Physical constraints associated with the pilones and burros within the large storage/fermentation warehouses, make it difficult to obtain constant accurate data. Current fermentation control experts, aside from their experience may use a thermometer in the room as well as one or more individual thermometers/hygrometers for the piles. Often, a fermentation director would use one thermometer/hygrometer, simply walking around to the different pilones. More than one thermometer/hygrometer may be used, but it is noted that such thermometers/hygrometers are simply instruments taking induvial readings, at various times only when used by the engineer.

All of the data that would otherwise be associated with this process would have a distinct impact on the flavor and character of the cigar. This data would be useful to not only the production staff, but also to marketing staff. Moreover, the purchaser currently only has access to limited marketing and promotional descriptions of the product with no access to actual production and transport data for a cigar. This lack of data integration across the full production to sale product chain does not allow the manufacture to properly associate product review and sales data with exact production data.

### OBJECTS AND SUMMARY

The present arrangement solves the shortcomings of the prior art and provides a system and arrangement for actively and continuously monitoring environmental conditions of tobacco fermentation in real time using an improved sensor arrangement. Such sensors and the related network are easily adaptable to provide real time environmental conditions of fermentation even in large warehouse environments.

Additionally, the present arrangement also provides and end to end data tracking arrangement that allows for the encoding and application of an NFC (Near Field Communication) chip to be included in the ring of a cigar. This ring is capable of linking to common site or data cell that can be used to track information about any one cigar (or group of cigars) so that all data about the cigar from the time it is manufactured until the time it is purchased can be accessible to manufacturer. Not only can the initial environmental data be uploaded to the common site or data cell, but subsequent data including, but not limited to aging, storage, transport, retail and sales information, as well as promotional data can be added as well providing an overall picture of the product. Moreover, this common site or data cell can have different layers of access associated therewith so that a manufacturer can see a full set of the data (including post sale review data entered by an end customer), whereas another layer of access can be afforded to a customer so that they can see promotional data as well as some limited version of the actual production data, and whereas retail and sales staff can also have anther layer of access in between that allows for review of customer and promotional data as well as a heightened view of production data that may be of use to them in retail and sales decisions.

To this end, a system is provided for tracking data related to a cigar. The system includes a tracking database configured to receive input from at least an environmental database for providing environmental data relating the manufacturer of the cigar to said tracking database, and at least one additional tracking system for providing subsequent data relating to the handling of the cigar, after manufacturer. The tracking database assembles a tracking database entry uniquely associated with the cigar. The tracking database entry also included at least the environmental data and the subsequent data relating to the handling of the cigar. The tracking database is configured to provide tracking database entry associated uniquely connected with the cigar to at least two different users, where each of the at least two different users can review the tracking database entry under a different level of access.

### BRIEF DECRIPTION OF THE DRAWINGS

The present invention can be best understood through the following description and accompanying drawing, wherein:

FIG. 1 illustrates an arrangement of a tobacco fermentation warehouse, with sensors, gateways and a DNCP server, in accordance with one embodiment;

FIG. 2 illustrates a data management pathway from gateways to an enterprise server and database, in accordance with one embodiment;

FIG. 3 illustrates the application of collected sensor data to an NFC chip on a cigar, in accordance with one embodiment;

FIG. 4 illustrates a flow chart for an exemplary application of an encoded chip on a cigar, in accordance with one embodiment;

FIG. 5 illustrates an exemplary initial data field entry in an enterprise database, associated with a particular NFC chip(s), in accordance with one embodiment;

FIG. 6 illustrates a schematic of a system for tracking additional transport information to be associated with a particular NFC chip(s), in accordance with one embodiment;

FIG. 7 illustrates an exemplary subsequent data field entry in an enterprise database, associated with a particular NFC chip(s), in accordance with one embodiment;

FIG. 8 illustrates a schematic of a system for tracking additional retail sales information to be associated with a particular NFC chip(s), in accordance with one embodiment;

FIG. 9 illustrates an exemplary subsequent data field entry in an enterprise database, associated with a particular NFC chip(s), in accordance with one embodiment;

FIG. 10 illustrates a schematic of a system for tracking additional consumer response information to be associated with a particular NFC chip(s), in accordance with one embodiment;

FIG. 11 illustrates an exemplary subsequent data field entry in an enterprise database, associated with a particular NFC chip(s), in accordance with one embodiment;

FIG. 12 illustrates a schematic of exemplary display terminals for various end users and viewers of collected data, connected to enterprises servers and data bases of the system, in accordance with one embodiment;

FIG. 13 illustrates an exemplary full data field entry in an enterprise database, associated with a particular NFC chip(s), with full access, in accordance with one embodiment;

FIG. 14 illustrates an exemplary data field entry in an enterprise database, associated with a particular NFC chip(s), with limited access, in accordance with one embodiment; and

FIG. 15 illustrates another exemplary data field entry in an enterprise database, associated with a particular NFC chip(s), with limited access, in accordance with one embodiment.

### DETAILED DESCRIPTION

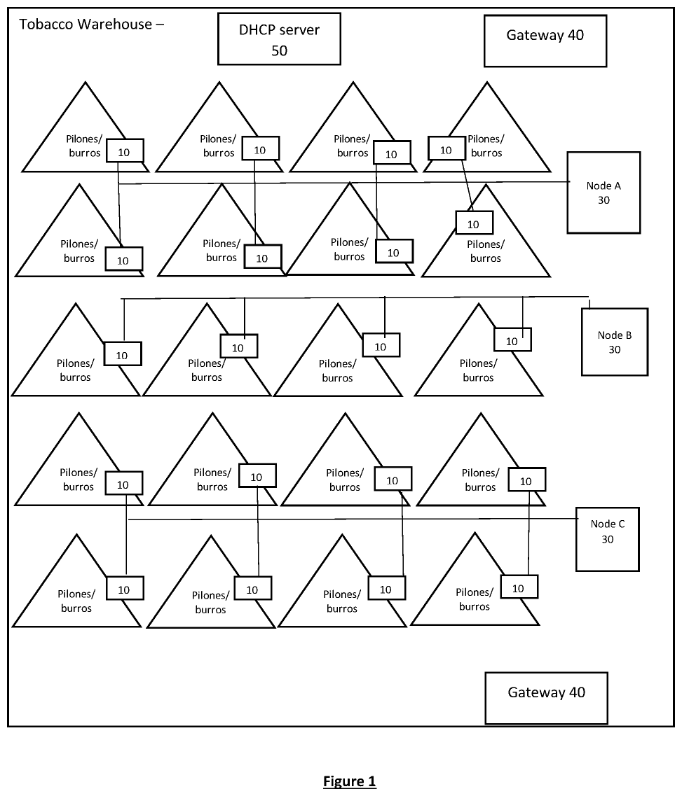

In one embodiment of the present arrangement as shown in FIGS. 1 sensor elements 10 are provided. In a preferred arrangement sensor 10 may have any one or more of thermometers, humidity detectors, and moisture detectors. It is noted that sensors 10 may have additional environmental detectors or less as desired by the engineer such as for example an ammonia detector. Additionally, such detectors and thermometers may be in various physical forms. For example, thermometer may be formed as a solid metal thermocouple as such design is more durable under the tobacco fermentation conditions. Additionally, the thermometers and detectors can be separate from one another or included on a common sensor chip.

As shown in FIG. 1 nodes 30s for collecting data may be coupled to eight sensors 10, and two or more nodes 30 may be each coupled to a gateway 40. A gateway is a wireless capable support device for coupling the wireless data being received from sensors 10, via nodes 30 to the cloud/internet and ultimately to a DNCP server 50 (described in more detail below). Each gateway 40 is capable of supporting data streams collected from up to two hundred and fifty nodes 30 depending on capacity.

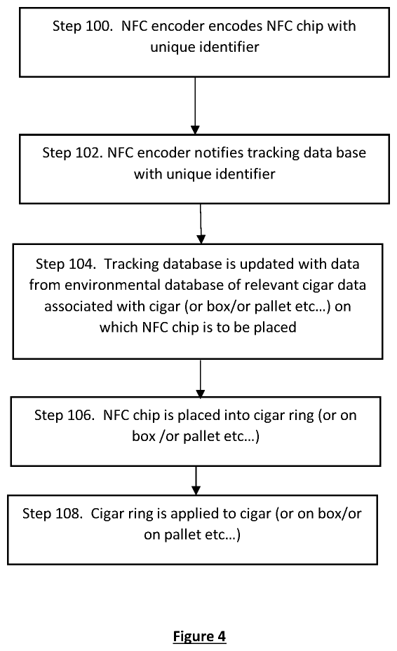

In the example shown in FIG. 1, there three nodes 30 in a warehouse, each one which is connected to a plurality of sensors 10, each of which turn inserted within one of the pilones or burros. It is noted that in a normal fermentation arrangement normally a fermentation floor would have either one of pilones or burros. FIG. 1 is only intended to show the schematic setup of gateway 40, nodes 30, and sensors 10. It is understood that that such arrangements can be used in large fermentation floors with many iterations over of the arrangement of FIG. 4. In fact, such arrangements of sensors 10 described herein may also be used outside of fermentation, including aging rooms, storage rooms etc . . . and any other area of tobacco production that would benefit from environmental controls.

Also included in the warehouse is at least one DNCP (Dynamic Node Configuration Protocol) server 50. The role of DNCP server 50 is to automatically assign radio network identifiers to nodes 30 and to correctly connect them with a preferred gateway 40. As shown in FIG. 1, there may be multiple gateways 40 in a single warehouse arrangement. For many reasons, such as physical constraints, distance, physical blockages (i.e. walls) overloaded networks etc . . . , for each node 30 any given gateway 40 may provide a better connection than another.

Because of the nature of the tobacco storage and fermentation warehouses, it may be that certain gateways 40 are better located or positioned within the room or near the room to a particular node 30. Additionally, given the large number of nodes 30 supported by each gateway 40, and the ever-changing nature and amounts of connected nodes 30 to any one gateway 40 (e.g. because of the constant formation and removal of pilones and the addition of new sensors 10/nodes 30 thereto) the node 30 uses the list provided by DNCP server 50 to determine a best gateway 40 among all available gateways 40 to connect to. It is noted that DNCP server 50 may be in communication with the multiple gateways 40 to maintain an accurate and update to list of available gateways for provision to requesting nodes 30.

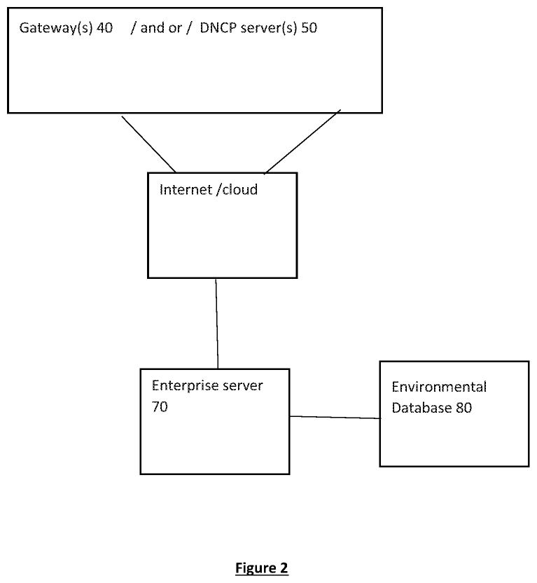

As illustrated in the FIG. 2 one or more gateways 40 from a particular tobacco processing facility are shown connected, for example via the cloud/internet, to an enterprise server 70 and connected environmental database 80. Server 70 and database 80 are together configured to ultimately collect, store and, otherwise make available for real time viewing the collected stream data from each of sensors 10.

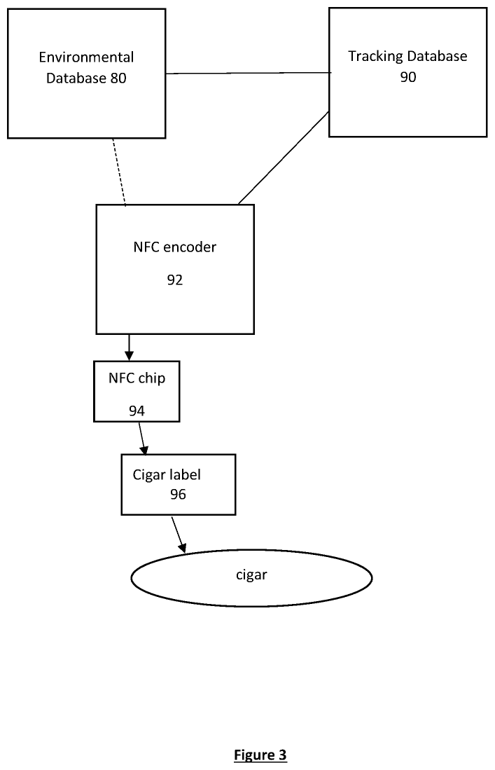

In one embodiment as shown in FIG. 3, a schematic is provided showing environmental database 80 being coupled to an enterprise tracking database 90, which is in turn connected to an NFC (Near Field Communication) encoder 92 that is configured to apply and connect a unique identifier code (200 described in more detail below) to an NFC chip 94. Once NFC chip 94 is encoded it can be applied to the inside of a cigar label 96 for eventual attachment to a cigar. It is noted that chip 94 is showed as applied to cigar label 96 on a cigar, but it is understood that a similar arrangement could apply such cigar chip to anyone of a cigar, a cigar bundle, a cigar box, a cigar crate or even a cigar pallet, or any combination thereof.

FIG. 4 shows an exemplary flow chart for applying the encoded chip 94 to a cigar. For example, at step 100, NCF encoder 92 encodes NFC chip 94 with a unique identifier code (200 see below). At step 102, NFC encoder 92 informs tracking database 90 with the data necessary to connect NFC chip 94 and its identity with the unique identifier code (200) to be associated with a particular cigar. At step 104 Tracking database 90 connects with environmental database 80 to collect the environmental data to be associated with that particular cigar and generate a tracking data base entry (300-described below), including that data as well as the unique identifier code (200). Next at step 106, NFC chip 94 is placed into cigar label, on a back side for example facing inward against the cigar, and the at step 108 cigar label 96 is affixed to the cigar for placement within the retail cigar box.

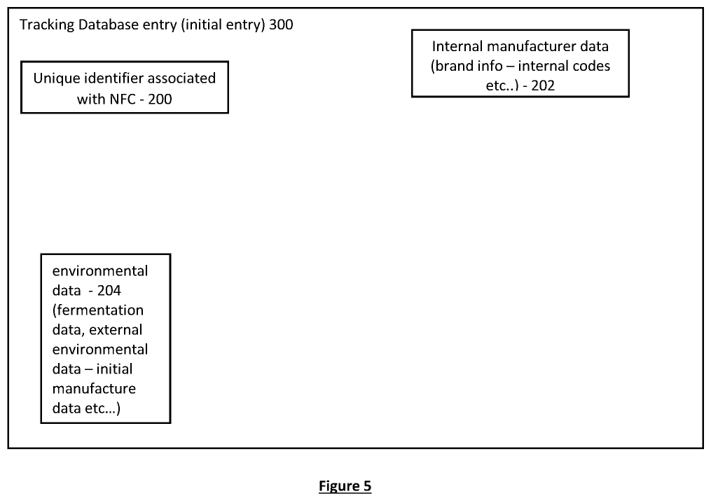

Turing to the data storage, FIG. 5 shows an exemplary data base entry 300 stored in tracking database 90 that is associated with a unique identifier 200 so that this entry 300 is associated with one cigar. As noted above, based on the data import from database 80 at step 104, database entry 300 includes an environmental data field 204 that includes such data collected from sensors 10 (fermentation data, external environmental data, initial manufacture data etc . . . ). Database entry 300 also may be provided with an internal manufacturing data field 202 that may include the name of the cigar brand, cigar name, and other related manufacturer data and internal coding. It is understood that such initial database entry 300 and the above-described data fields 200, 202, and 204 are intended to be examples, and other useful data fields may be added by the manufacturer as desired.

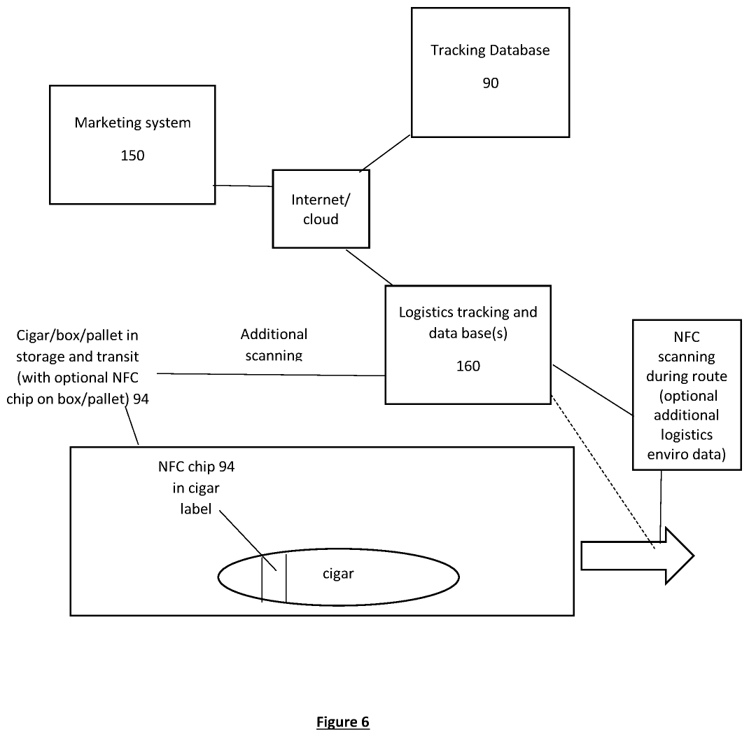

FIG. 6 illustrates a schematic of additional tracking components used to add field data to tracking database entry 300. As shown in FIG. 6, tracking database 90 is additionally connected to a marking system 150 as well as logistics database 160. Marketing system 150 allows the manufacturer to attach additional marketing data to tracking database entry 300. Logistics and tracking database 160 is connected to various local NFC scanning locations during the supply chain routes to collect various data about the transport of the cigar. For example, the environmental data and length/time of transport can be collected at various locations and collected by connected logistics database 160 to be delivered back to primary enterprise tracking database 90.

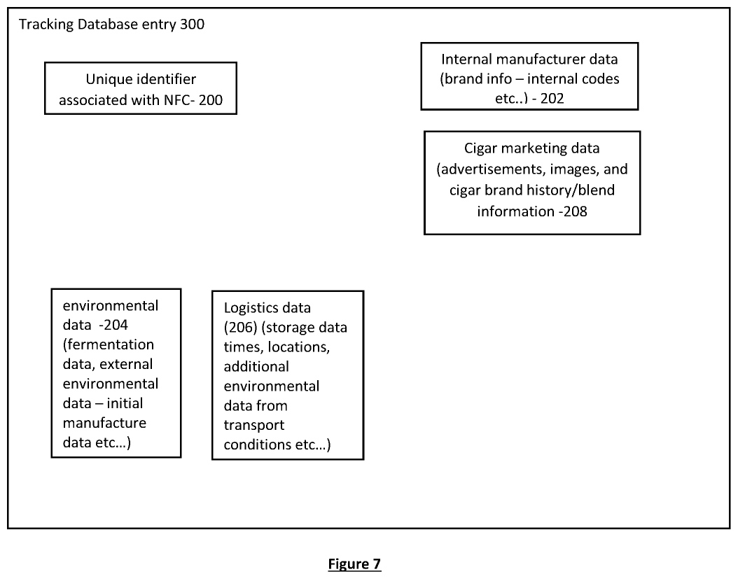

FIG. 7 shows an updated tracking database entry 300 associated with unique identifier 200, also now including additional marketing and logistics data. For example, as shown in FIG. 7, database entry 300, in addition to initial fields 200, 202, and 204, has added logistics data field 206 that may include for example, storage data, times, locations, and additional environmental data associated with the transport of the cigar. Also, entry 300 includes cigar marketing data field 208 that may include for example, advertisements, images, and cigar brand history/tobacco blend information etc . . .

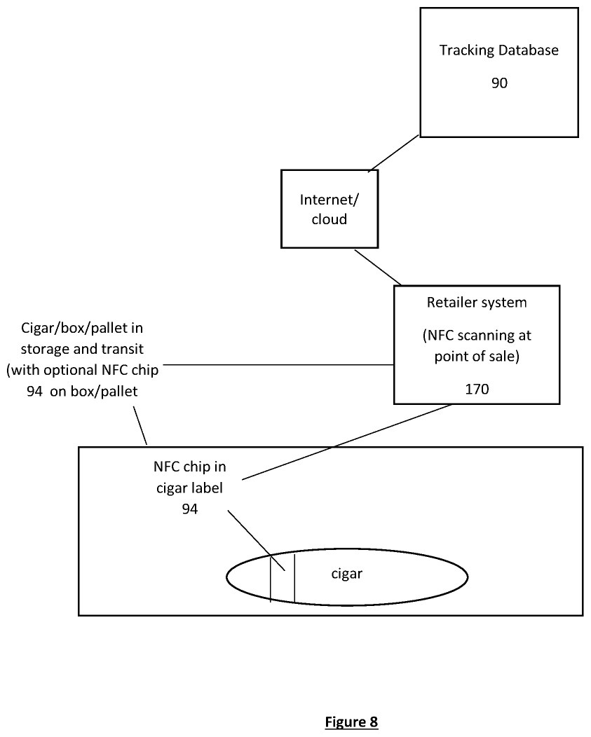

FIG. 8 illustrates a schematic of additional tracking components used to add field data to tracking database entry 300. As shown in FIG. 8, tracking database 90 is additionally connected to a retailer data collection system 170 that allows the manufacturer to attach additional retail sales data to tracking database entry 300. For example, retail system 170 includes NFC collected data from boxes and cigars (point of sale data) including the date of purchase, price and other such data to be delivered back to primary enterprise tracking database 90. It is noted that retail system 170 may be located directly at various retail locations or alternatively may be a regional system 170 that collects inputs from independently located retail servers.

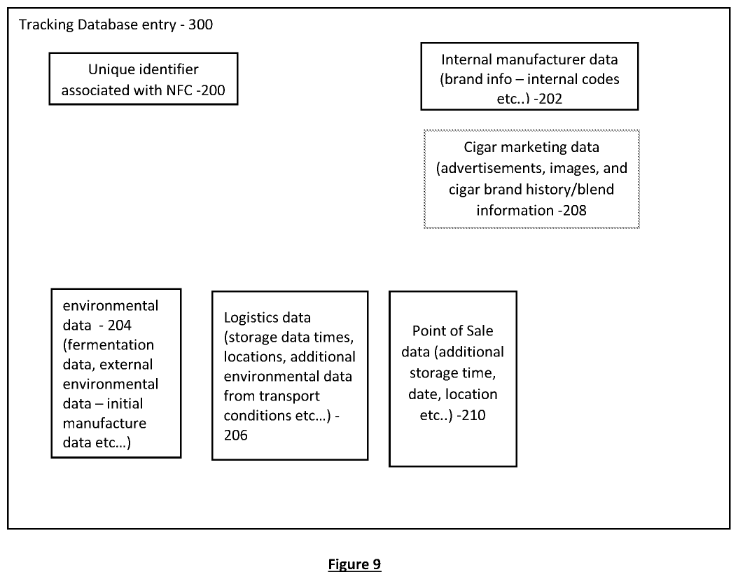

FIG. 9 shows an updated tracking database entry 300 associated with unique identifier 200, also now including additional retail sales data. For example, as shown in FIG. 9, database entry 300, in addition to fields 200, 202, 204, 206, and 208 has added point of sales data field 210 that may include for example, additional storage times, price of sale, and location of sales etc . . .

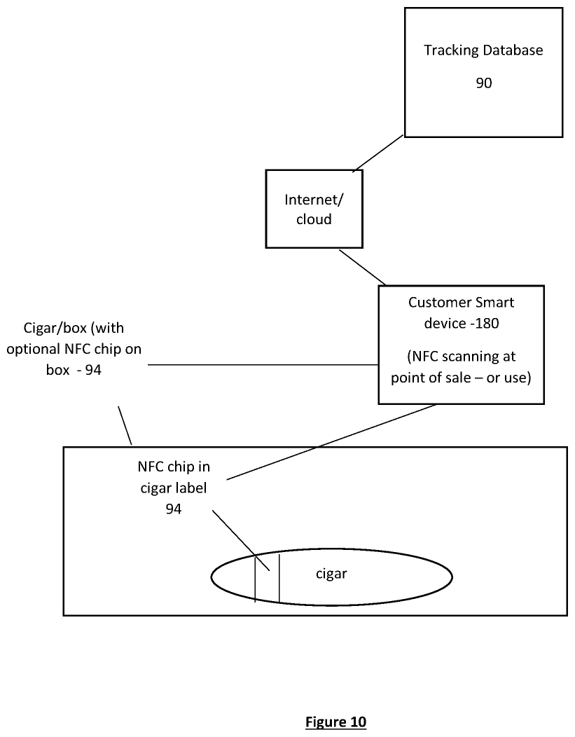

FIG. 10 illustrates a schematic of additional tracking components used to add field data to tracking database entry 300. As shown in FIG. 10, tracking database 90 is additionally connected to a customer smart device data collection system 180 that allows the manufacturer to attach additional direct customer input data to tracking database entry 300. For example, customer system 180 includes NFC collected data from cigars input by the users including the date of use, customer review, customer demographic data and other such data to be delivered back to primary enterprise tracking database 90. It is noted that retail system 180 may be located directly as an application on various user smart devices or alternatively may be a regional system 180 that collects inputs from independently uploaded customer computers/smart devices.

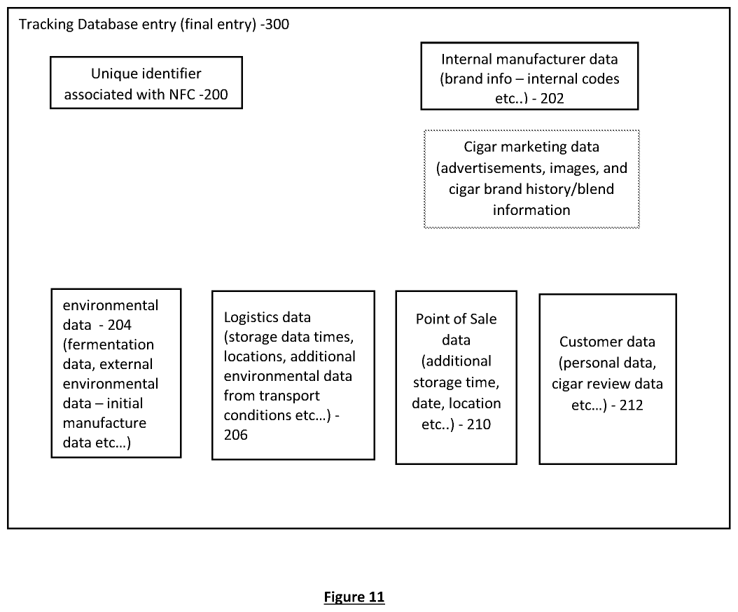

FIG. 11 shows an updated tracking database entry 300 associated with unique identifier 200, also now including additional customer input data. For example, as shown in FIG. 11, database entry 300, in addition to fields 200, 202, 204, 206, 208, and 210, has added customer input data field 212 that may include for example, the demographic information of the purchaser, date of smoking, customer reviews etc . . .

As such, based on the above, and as shown in FIG. 11, tracking database entry 300, associated with a single unique identifier 200 includes data fields that encompass all data from the point of manufacture, all the way through to an end use of the cigar and associated review data by the customer, as per data fields 202 -212, collected at various stages using the scanning of NFC chip 94 that was attached at manufacturer.

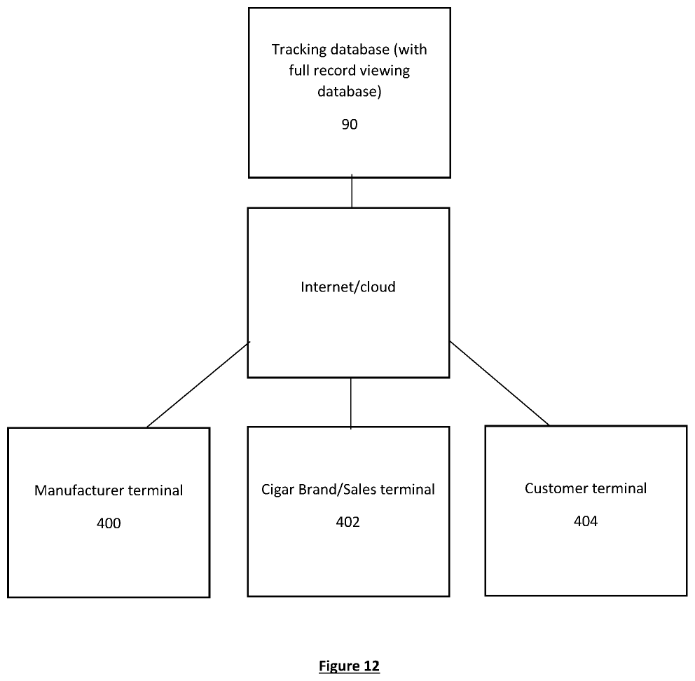

Turing to the use of such information as contained in tracking database entry 300, FIG. 12 shows an exemplary schematic of tracking database 90 in connection with a manufacturer viewing terminal 400, a cigar brand/sales terminal 402, and a customer terminal 404 (or smart device). It is contemplated that any one of tracking database entry 300 for any number of cigars may be viewable on such terminals in various different versions with different levels of access depending on how the manufacturer would like such information to be disclosed/available.

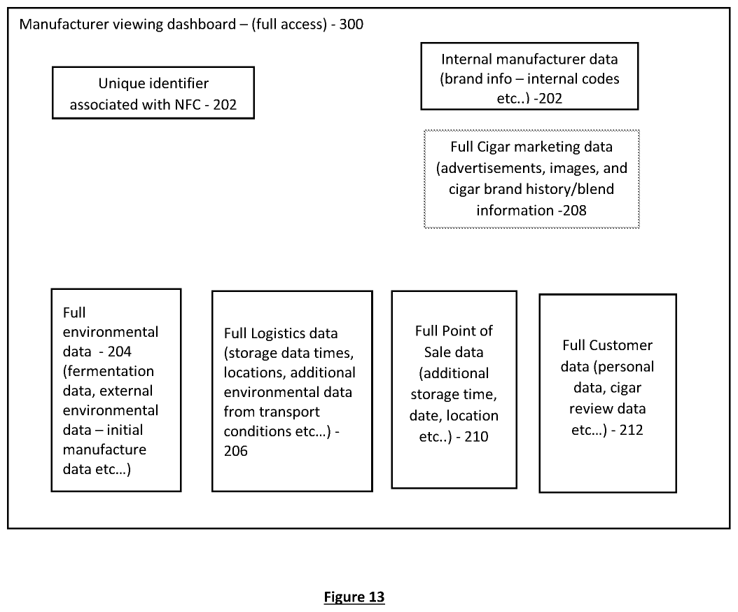

For example, FIG. 13 shows one version of tracking database entry 300 showing full access as viewable on manufacturer terminal 400. In this instance, manufacturer has access to all data fields including the unique identifier field 200, internal manufacturing data field 202, environmental data field 204, logistics data field 206, cigar marketing data field 208, point of sale/retail data field 210, and customer data field 212, with each filed including a full version of all such data in these fields. In one example, a manufacturer may be able to correlate how the environmental data 204 impacted customer reviews in field 212 and may even be able to see how logistics and retail data from fields 206 and 210 may have impacted flavor/reviews.

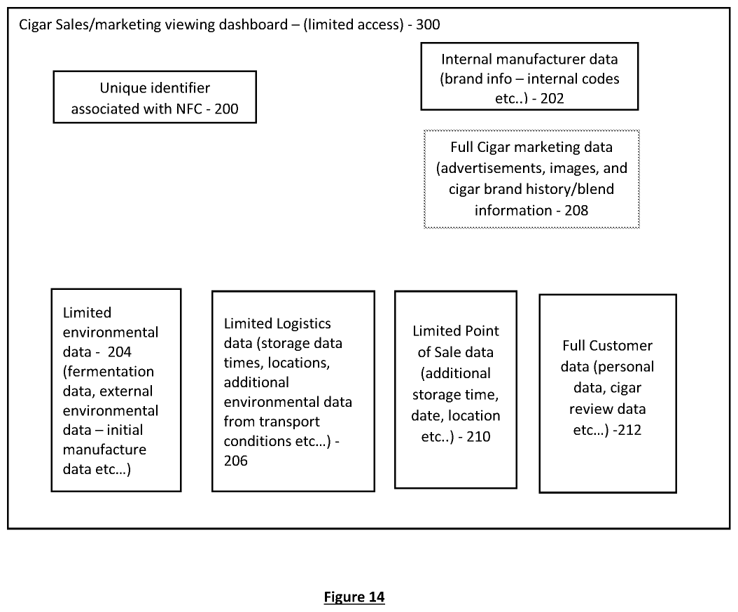

In another embodiment, FIG. 14 shows another version of tracking database entry 300 showing limited access as viewable on sales retail terminal 402. This version of database entry 300 may remove some of the granular data not required by the manufacturers marketers (in house or third party), but still enough to provide valuable information about how manufacturing, logistics, and sales data impact customer satisfaction, and how certain demographics of customers may affect marketing and sales directions for different cigars.

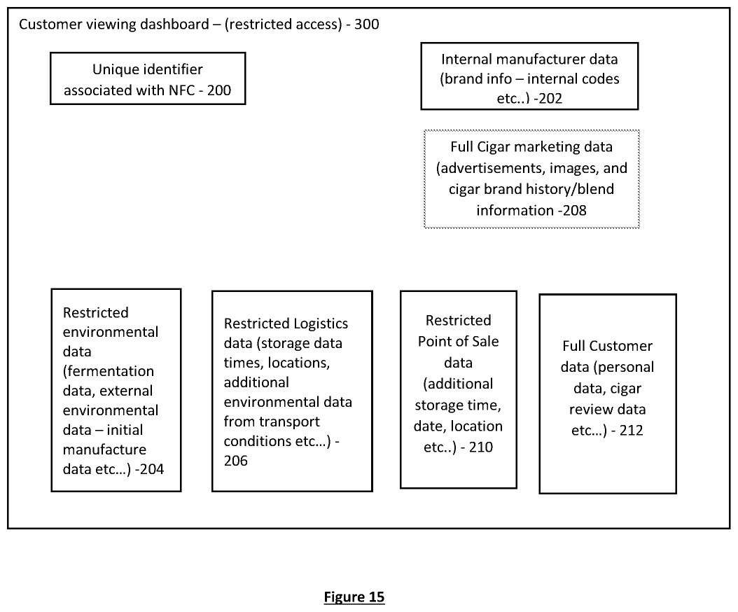

In another embodiment, FIG. 15 shows another version of tracking database entry 300 showing limited access as viewable on customer terminals 404. Here the customer may review primarily the unrestricted marketing data in marketing field 208, but also may have access to the other remaining fields in a restricted manner. For example, a customer may be interested in knowing some limited fermentation data or locations which could help them with future purchases and remaining brand loyal, without the need to see the full granular environmental data available only to the manufacturer.

It is noted that FIGS. 13-15 are considered exemplary versions of full versus limited access to data and data fields contained in tracking database entry 300. Additional versions of access levels may be provided as desired by the manufacturer and adjustments to the levels of access as shown in FIGS. 13-15 are all within the contemplation of the present invention.

While only certain features of the invention have been illustrated and described herein, many modifications, substitutions, changes, or equivalents will now occur to those skilled in the art. It is therefore, to be understood that this application is intended to cover all such modifications and changes that fall within the true spirit of the invention.

What is claimed is:

1. A system for tracking data related to a cigar, said system comprising:
a tracking database, said tracking database configured to receive input from at least an environmental database for providing environmental data relating the manufacturer of the cigar to said tracking database;
at least one additional tracking system for receiving subsequent data relating to the handling of the cigar, after manufacturer;
wherein said tracking database assembles a tracking database entry uniquely associated with said cigar, said tracking database entry also including at least said environmental data and said subsequent data relating to the handling of the cigar, and
wherein said tracking database is configured to provide a tracking database entry associated uniquely connected with said cigar to at least two different users, where each of said at least two different users can review said tracking database entry under a different level of access.

2. The system as claimed in claim 1, wherein said at least one tracking system is connected to a marketing system, for providing marketing data to be included in said database entry uniquely associated with said cigar.

3. The system as claimed in claim 1, wherein said at least one tracking system is connected to a logistics and tracking system, for providing logistics and tracking data to be included in said database entry uniquely associated with said cigar.

4. The system as claimed in claim 1, wherein said at least one tracking system is connected to a retail tracking system, for providing retail sales data to be included in said database entry uniquely associated with said cigar.

5. The system as claimed in claim 1, wherein said at least one tracking system is connected to a customer device system, for providing customer input data to be included in said database entry uniquely associated with said cigar.

6. The system as claimed in claim 1, wherein said tracking database entry uniquely associated with said cigar, includes at least said environmental data,
and wherein said subsequent data relating to the handling of the cigar includes marketing data, logistics and tracking data, retail sales data and said customer input data.

7. The system as claimed in claim 6, wherein said one of said at least two users reviewing said tracking database entry associated with said cigar is a manufacturer of said cigar and wherein said level of access to said tracking database entry is unrestricted.

8. The system as claimed in claim 6, wherein said one of said at least two users reviewing said tracking database entry associated with said cigar is a retail sales agent of said cigar and wherein said level of access to said tracking database entry is limited to include less than all of the data in said tracking database entry.

9. The system as claimed in claim 6, wherein said one of said at least two users reviewing said tracking database entry associated with said cigar is a customer/purchaser of said cigar and wherein said level of access to said tracking database entry is restricted to include less than all of the data in said tracking database entry.

10. A method for tracking data related to a cigar, said method comprising the steps of:
receiving input at a tracking database from at least an environmental database for that provides environmental data relating the manufacturer of the cigar to said tracking database;
receiving subsequent data at an additional tracking system relating to the handling of the cigar, after manufacturer;
assembling by tracking database a tracking database entry uniquely associated with said cigar, said tracking database entry also including at least said environmental data and said subsequent data relating to the handling of the cigar, and
providing, by said tracking database, a tracking database entry associated uniquely connected with said cigar to at least two different users, where each of said at least two different users can review said tracking database entry under a different level of access.

11. The method as claimed in claim 10, further comprising the step of providing marketing data to be included in said database entry uniquely associated with said cigar.

12. The system as claimed in claim 10, further comprising the step of providing logistics and tracking data to be included in said database entry uniquely associated with said cigar.

13. The system as claimed in claim 10, further comprising the step of providing retail sales data to be included in said database entry uniquely associated with said cigar.

14. The system as claimed in claim 10, further comprising the step of providing customer input data to be included in said database entry uniquely associated with said cigar.

15. The system as claimed in claim 10, further comprising the step of including at least environmental data in said tracking database entry uniquely associated with said cigar, wherein said subsequent data relating to the handling of the cigar includes marketing data, logistics and tracking data, retail sales data and said customer input data.

16. The system as claimed in claim 15, further comprising the step of a manufacturer of said cigar reviewing said tracking database entry associated with said cigar, wherein said level of access to said tracking database entry is unrestricted.

17. The system as claimed in claim 15, further comprising the step of a retail sales agent reviewing said tracking database entry associated with said cigar, wherein said level of access to said tracking database entry is limited to include less than all of the data in said tracking database entry.

18. The system as claimed in claim 15, further comprising the step of a customer/purchaser of said cigar reviewing said tracking database entry associated with said cigar wherein said level of access to said tracking database entry is restricted to include less than all of the data in said tracking database entry.
